(19) United States
(12) Patent Application Publication
(10) Pub. No.: US 2012/0307083 A1
(43) Pub. Date: Dec. 6, 2012

(54) IMAGE PROCESSING APPARATUS, IMAGE PROCESSING METHOD AND COMPUTER READABLE INFORMATION RECORDING MEDIUM

(76) Inventor: Kenta NAKAO, Tokyo (JP)

(21) Appl. No.: 13/466,465

(22) Filed: May 8, 2012

(30) Foreign Application Priority Data
Jun. 1, 2011 (JP) 2011-123438
Apr. 26, 2012 (JP) 2012-100579

(51) Int. Cl. H04N 5/225

(52) U.S. Cl. 348/207.99; 348/E05.024

(57) ABSTRACT

An image processing apparatus selects sets of image data that can be combined together based on appended information concerning the image data taken by an image pickup apparatus. The image processing apparatus selects, based on certain information included in the appended information, sets of the image data having positions of the image data taken within a certain area and stores the selected sets of image data in a first storage area; when plural sets of the image data have been stored in the first storage area, determines whether there are overlapping-possible areas between the plural sets of image data, and, when there are overlapping-possible areas between the plural sets of image data, calculates the overlapping-possible areas as comparison areas; determines whether the plural sets of image data coincide in the comparison areas; and classifies the plural sets of image data based on the determination result.

### BACKGROUND OF THE INVENTION

1. Field of the Invention

The present invention relates to an image processing apparatus, an image processing method and a computer readable information recording medium, for selecting plural sets of image data which can be combined together, based on information appended to the image data taken by an image pickup apparatus.

2. Description of the Related Art

Recently, an image processing system is known in which a digital camera and a computer are connected together, image data taken by the digital camera is read in the computer, and various sorts of processing are carried out on the image data (see Patent reference 1 (shown later)). This image processing system carries out a photograph combination process in which plural photographs photographed using the digital camera are combined together in such a manner that overlapping parts thereof are superposed together, and thus a continuous set of image data is generated (see Patent reference 2 (shown later)).

Concerning such a type of photograph combination processing, a technique of automatically selecting photographs to be combined together is known. For example, a file selecting apparatus or the like is known in which plural image files having geographical positions at a time of photographing within a certain distance are selected as image files that can be used to generate a panoramic image (see Patent reference 3 (shown later)).

In the above-mentioned technique of automatically selecting image files that can be used to generate a panoramic image, it is necessary to, when taking photographs, continuously hold a camera at a fixed height from the ground, move the camera horizontally and keep a fixed inclination of the camera in a vertical direction, as prerequisites.

That is, according to the technique in the related art, in a case where these prerequisites are not satisfied, accuracy in selecting photographs to be used to carry out a photograph combination process may be degraded, and a likelihood of selecting photographs that cannot be combined may be increased.

### SUMMARY OF THE INVENTION

According to one aspect of the present invention, an image processing apparatus selects sets of image data that can be combined together, based on appended information concerning the image data taken by an image pickup apparatus. The image processing apparatus includes a storage part configured to select, base on certain information included in the appended information, sets of the image data having positions of the image data taken within a certain area and store the selected sets of image data in a first storage area. The image processing apparatus further includes a comparison area calculation part configured to, when plural sets of the image data have been stored in the first storage area, determine whether there are overlapping-possible areas between the plural sets of image data, and, when there are overlapping-possible areas between the plural sets of image data, calculate the overlapping-possible areas as comparison areas. The image processing apparatus further includes an image data comparison part configured to determine whether the plural sets of image data coincide with each other in the comparison areas; and a classification part configured to classify the plural sets of image data based on a determination result of the image data comparison part.

It is noted that the above-mentioned one aspect of the present invention may be realized as a method of carrying out the respective operations, and as a program to cause a computer to carry out the respective operations.

Other objects, features and advantages of the present invention will become more apparent from the following detailed description when read in conjunction with the accompanying drawings.

### BRIEF DESCRIPTION OF THE DRAWINGS

FIG. 1 illustrates an image processing system according to a first embodiment of the present invention;

FIG. 2 illustrates functions of each of apparatuses included in the image processing system shown in FIG. 1;

FIG. 3 illustrates functions of an image information analysis part shown in FIG. 2;

FIG. 4 illustrates functions of an image data comparison part shown in FIG. 2;

FIG. 5 illustrates functions of an image data classification part shown in FIG. 2;

FIG. 6 is a flowchart illustrating operations of an image data selection part shown in FIG. 2 according to the first embodiment;

FIG. 7 illustrates calculation of data comparison areas according to the first embodiment;

FIG. 8 illustrates comparison of data comparison areas by the data comparison part according to the first embodiment;

FIGS. 9A and 9B illustrate calculation of data comparison areas according to a second embodiment of the present invention; and

FIGS. 10A, 10B and 10C illustrate comparison of data comparison areas by the data comparison part according to the second embodiment.

### DETAILED DESCRIPTION OF THE EMBODIMENTS

Embodiments of the present invention have been devised in consideration of the above-mentioned problem, and an object of the embodiments is to provide an image processing apparatus, an image processing method and a computer readable information recording medium, by which it is possible to select photographs to be used for a photograph combination process without specific prerequisites.

According to the embodiments of the present invention, plural sets of image data having position information within a certain area are stored in one folder, which information indicates positions at which the plural sets of image data have been taken by an image pickup apparatus. Then, as to plural sets of image data having overlapping-possible areas stored in the folder, the overlapping-possible areas are extracted, and are stored in another folder.

### First Embodiment

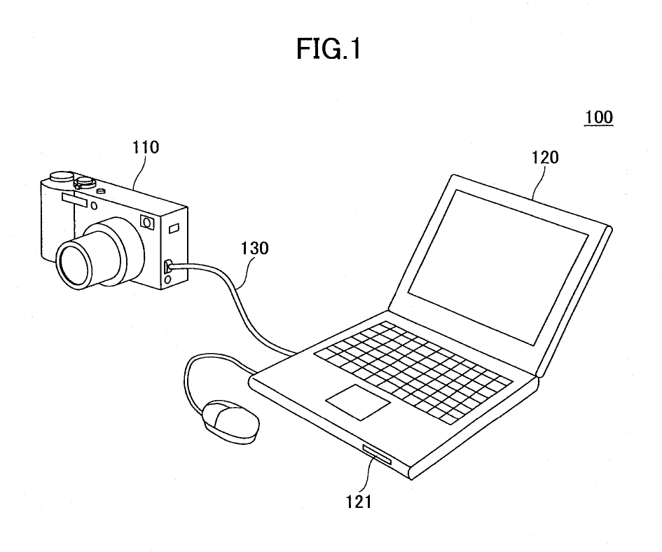

Below, a first embodiment of the present invention will be described using drawings. FIG. 1 illustrates an image processing system 100 according to the first embodiment of the present invention.

The image processing system 100 includes a digital camera 110 (image pickup apparatus) and an image processing apparatus 120, which are connected together by a cable 130. The digital camera 110 acts as an input apparatus that generates image files. The image processing apparatus 120 is a computer that displays the image data and carries out image processing on the image data. The image processing apparatus 120 has a memory card insertion part 121 having a slot through which a memory card (not shown) that stores the image files generated by the digital camera 110 is inserted into the memory insertion part 121.

In the image processing system 100, the image files generated by the digital camera 110 are transferred to the image processing apparatus 120 through the cable 130 or the memory card inserted into the memory card insertion part 121. It is noted that the image files generated by the digital camera 110 may be stored in a portable recording medium other than a memory card. Further, in the recording medium or the memory card, an image processing program for carrying out image processing by the image processing apparatus 120 described later may be stored. In a case where the image processing program is stored in the recording medium or the memory card, the image processing apparatus 120 may read the image processing program from the recording medium or the memory card, and load the image processing program in a memory (described later), and a central processing unit (CPU) (described later) may execute the image processing program.

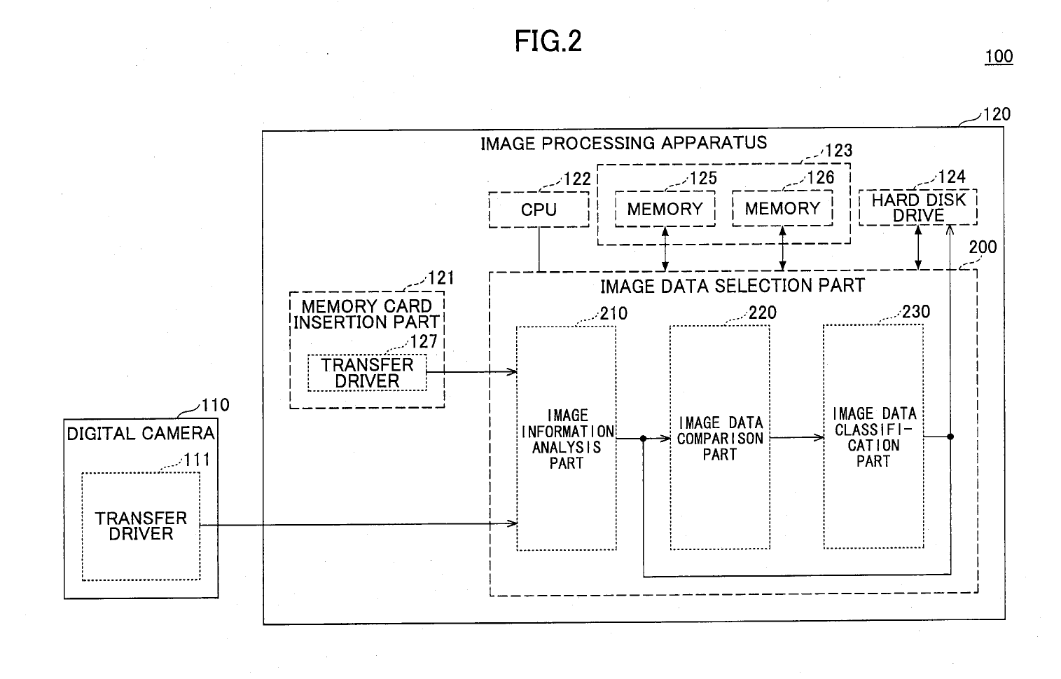

FIG. 2 illustrates functions of each of the apparatuses included in the image processing system 100.

The digital camera 110 has a transfer driver 111. The image processing apparatus 120 has the memory card insertion part 121, a CPU 122, a memory unit 123, a hard disk drive 124 and an image data selection part 200.

When the digital camera 110 is connected with the image processing apparatus 120 and receives an instruction to transfer image files from the digital camera 110, the digital camera 110 outputs the image files as image data expanded into a form of a bit map using the transfer driver 111. The output image data is transferred to the image data selection part 200. The above-mentioned instruction to transfer the image files from the image processing apparatus 120 may be output by an image file transfer application or the like installed in the image processing apparatus 120, for example.

In the image processing apparatus 120, the memory card insertion part 121 has a transfer driver 127. In a case where the image files generated by the digital camera 110 are stored in the memory card that is inserted into the memory card insertion part 121, the image files are expanded into image data through the transfer driver 127 and are transferred to the image data selection part 200. The CPU 122 controls the entirety of the image processing apparatus 120. The memory unit 123 includes memories 125 and 126, and stores processing results of the CPU 122 and/or the image data selection part 200, various sorts of set values of the image processing apparatus 120, and so forth. The hard disk drive 124 stores, for example, the image data generated by the digital camera 110, various sorts of application programs, and so forth.

When the image data is thus transferred to the image data selection part 200, the image data selection part 200 selects plural sets of image data that can be combined together from the transferred image data. Below, details of the image data selection part 200 will be described.

The image data selection part 200 includes an image information analysis part 210, an image data comparison part 220 and an image data classification part 230.

The image information analysis part 210 analyzes the plural sets of image data that are input to the image data selection part 200. Then, based on the analysis result of the image information analysis part 210, the image data comparison part 220 compares the plural sets of image data. The image data classification part 230 classifies the plural sets of image data in a case where it has been determined as a result of the comparison that the plural sets of image data can be combined together.

Below, details of the respective parts of the image data selection part 200 will be described. It is noted that below, explanation will be made for a case where two sets of image data are input to the image data selection part 200, for convenience of explanation, and, of course three or more sets of image data may be input to the image data selection part 200.

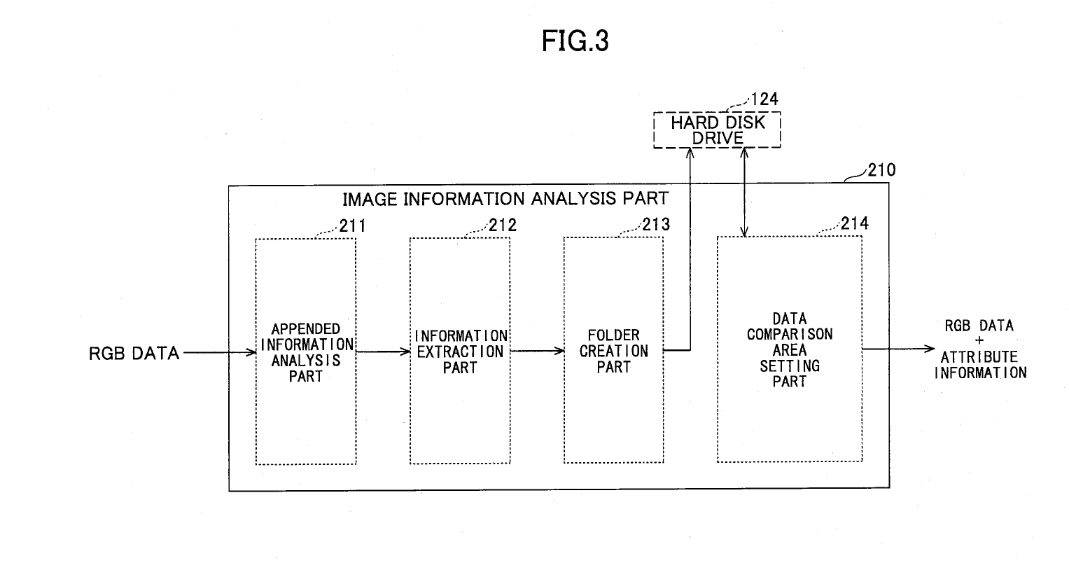

FIG. 3 illustrates functions of the image information analysis part 210 shown in FIG. 2. The image information analysis part 210 includes an appended information analysis part 211, an information extraction part 212, a folder creation part 213 and a data comparison area setting part 214.

When the image data is input from the digital camera 110 or the memory card, the appended information analysis part 211 analyzes appended information appended to the image data. The appended information includes data according to an image file format standard for a digital still camera “Exchangeable image file format” (Exif) made by Japan Electronics and Information Technology Industries Association (JEITA).

The information extraction part 212 extracts certain information from the analyzed appended information. Specifically, the certain information that the information extraction part 212 extracts from the analyzed appended information includes position information indicating the positions (i.e., photographing points) at which photographs have been photographed; position information indicating the positions of the photographed objects; distances between the photographed objects and the photographing points; the angles indicating the directions of the photographs; the inclinations of the bottom of the camera with respect to the horizontal direction at the times of photographing; the focal lengths at the times of photographing; and the widths and heights of the images (photographs). The information extraction part 212 appends the extracted certain information to the image data of the photographs, and, outputs the image data together with the extracted certain information to the folder creation part 213. The certain information will be referred to as “attribute information” hereinafter.

The folder creation part 213 creates a folder according to the position information indicating the positions (photographing points) at which photographs have been photographed. For example, each folder is created for storing sets of image data (photographs) having the position information indicating the photographing points within a certain area. The certain area is a predetermined area, and is previously set and may be set freely. Further, at the time of thus creating a folder, the folder creation part 213 creates a corresponding folder name concerning the corresponding position information of the photographing point. When the folder creation part 213 has thus created a folder, the folder creation part 213 stores sets of image data (photographs) in the folder corresponding to the position information included in the attribute information of the respective sets of the image data.

For example, the folder creation part 213 may create a folder having a building's name as the folder name for storing sets of image data having the position information that indicates as respective photographing points the inside of the same building. Then, the folder creation part 213 stores sets of image data of photographs photographed in the building of the building's name in the folder having the building's name. Further, the folder creation part 213 may create a folder having a town's name as the folder name for storing sets of image data having the position information that indicates as respective photographing points the inside of the same town's name, and stores sets of image data of photographs photographed in the town of the town's name in the folder having the town's name.

When the folder creation part 213 has thus stored sets of image data in a created folder, the folder creation part 213 creates folder correspondence information that indicates the correspondence between the sets of image data and the folder name of the folder that stores the sets of image data, and includes the folder correspondence information in the attribute information.

In a case where plural sets of image data exist in a folder, the data comparison area setting part 214 calculates areas of the respective sets of image data at which areas there is a likelihood that the sets of image data in the folder overlap each other, by a method described later. It is noted that “overlapping of sets of image data” may mean that the same object (in particular, a fixed object such as a landscape, for example) is in the plural sets of image data, for example.

Then, the data comparison area setting part 214 sets the area thus calculated for each set of image data as a data comparison area, and includes set values of the data comparison area in the attribute information. The data comparison setting part 214 repeats this processing the number of times corresponding to the number of folders in each of which plural sets of image data are stored.

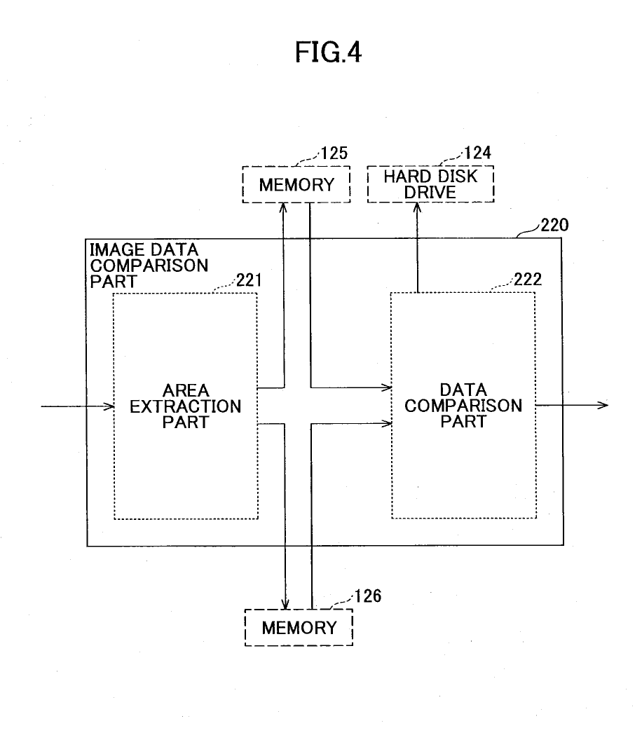

Next, using FIG. 4, the image data comparison part 220 will be described. FIG. 4 illustrates functions of the image data comparison part 220.

The image data comparison part 220 includes an area extraction part 221 and a data comparison part 222. The area extraction part 221 extracts the image data included in the respective two data comparison areas of the above-mentioned two sets of image data based on the above-mentioned set values of these data comparison areas included in the attribute information that has been output from the image information analysis part 210. The area extraction part 221 stores the extracted image data of one of the two data comparison areas in the memory 125, and the extracted image data of the other of the two data comparison areas in the memory 126.

The data comparison part 222 reads the image data stored in the memories 125 and 126, respectively, and determines whether the read sets of image data have a likelihood of overlapping each other.

A specific method of the determination is as follows. For example, the pixels in the entireties of the respective data comparison areas may be compared. It is noted that the image processing apparatus 120 is realized by a general-purpose computer as mentioned above. However, the image processing apparatus 120 may be realized by, for example, a printer that carries out image forming operations. In this case, the above-mentioned method of the determination may be preferably a pattern matching process of comparing partially edges using a high pass filter in consideration of the memory capacity or the like of the printer.

When having determined that the two sets of image data read from the respective memories 125 and 126 include parts that coincide with one another, the data comparison part 222 includes coordinate information on the respective image surfaces, in the attribute information, and outputs the attribute information to the image data classification part 230. At this time, the data comparison part 222 also outputs the two sets of image data (in the data comparison areas) read from the respective memories 125 and 126 to the image data classification part 230 together with the attribution information. The coordinate information on the respective image surfaces means information indicating coordinates of groups of pixels that have been determined to coincide with one another in the areas extracted by the area extraction part 221. The coordinate information indicating the groups of pixels that have been determined to coincide with one another is then included in the attribute information. Specifically, for example, assuming that the coordinates of one of the groups of pixels that have been determined to coincide with one another are “x=64 through 100” and “y=32 through 50”, only the following four values are to be stored, i.e., x=64; y=32; x_count=100−64+1=37; and y_count=50−32+1=19. Thus, the information amount of the attribute information can be reduced.

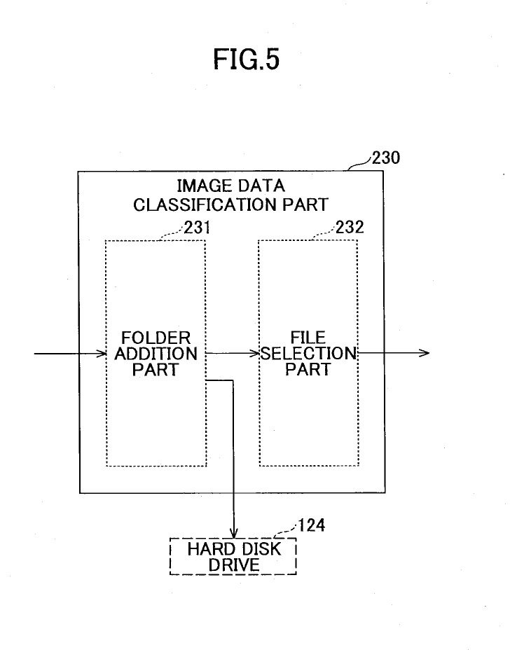

Next, using FIG. 5, the image data classification part 230 will be described. FIG. 5 illustrates functions of the image data classification part 230.

The image data classification part 230 includes a folder addition part 231 and a file selection part 232.

When the image data and the attribute information are input from the image data comparison part 220 to the image data classification part 230, the folder addition part 231 creates a new folder to store the input image data. The folder addition part 231 adds the character string “(combinable)” to the folder name included in the folder correspondence information included in the input attribute information to create a folder name, and thus creates the new folder having the created folder name.

The new folder added by the folder addition part 231 is created in the hard disk drive 124. The folder addition part 231 includes the folder name of the new folder in the folder correspondence information, and outputs the image data and the attribute information to the file selection part 232.

The file selection part 232 stores the image data and the attribute information in the new folder created by the folder adding part 231. The attribute information includes the certain information extracted by the information extraction part 212; the folder correspondence information including the folder name of the folder in which the image data is thus stored; the set values of the data comparison areas; and the coordinate information on the image surfaces.

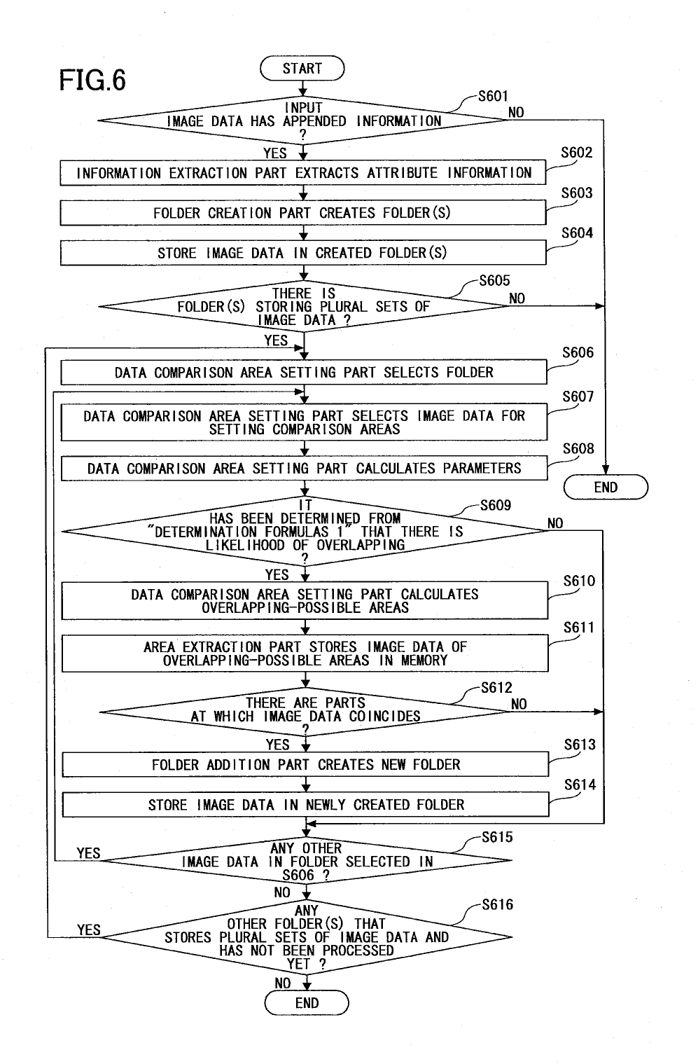

Below, using FIG. 6, operations of the above-described image data selection part 200 will be described. FIG. 6 is a flowchart illustrating operations of the image data selection part 200.

The image data selection part 200 determines whether image data that has been input to the appended information analysis part 211 has appended information (step S601). It is noted that the appended information is information which is stored at locations determined by Exif made by JEITA.

In a case where it has been determined that there is no appended information (step S601 NO), the image data selection part 200 finishes the process. In a case where it has been determined that there is appended information (step S601 YES), the image data selection part 200 extracts the above-mentioned certain information (attribute information) from the appended information (step S602).

Next, the folder creation part 213 creates a folder(s) to store the image data according to the “position information indicating the positions (photographing points) at which the photographs have been photographed” included in the attribute information (step S603). Next, the folder creation part 213 stores the corresponding image data in the created folder(s) (step S604). At this time, the folder creation part 213 includes the folder correspondence information in the attribute information, and also stores the attribute information in the folder(s) together with the image information.

Next, the data comparison area setting part 214 determines whether there is the folder(s) that stores plural sets of image data (corresponding to plural photographs) (step S605). In a case where there is not the corresponding folder (step S605 NO), the image selection part 200 finishes the process. In a case where there is the corresponding folder(s) (step S605 YES), the data comparison area setting part 214 selects the folder that stores plural sets of image data (step S606). It is noted that in a case where there are the plural corresponding folders in step S605, the data comparison area setting part 214 may select the folders in the order in which the attribute information of the image data has been extracted.

Next, in step S607, the data comparison area setting part 214 selects two sets of image data (corresponding to two photographs), for which data comparison areas will beset, from the folder selected in step S606. It is noted that in a case where three or more sets of image data are stored in the single folder, the data comparison area setting part 214 may select the two sets of image data that have been stored in the folder earlier.

After thus selecting the two sets of image data from the folder in step S607, the data comparison area setting part 214 calculates parameters to be used for calculating the data comparison areas using formulas (3) and (4) described later (step S608). Next, using “Determination Formulas 1” described later, the data comparison area setting part 214 determines whether the selected two sets of image data have a likelihood of overlapping one another (step S609). In a case where it has been determined that the selected two sets of image data do not have a likelihood of overlapping one another (step S609 NO), the data comparison area setting part 214 proceeds to step S615 described later. It is noted that the comparison of image data to determine whether the selected two sets of image data have a likelihood of overlapping one another as mentioned above is carried out using copies of the corresponding image data that are stored in the hard disk drive 124.

In a case where it has been determined that the two sets of image data have a likelihood of overlapping one another (step S609 YES), the data comparison area setting part 214 determines set values in width directions and set values in a height direction of the data comparison areas using formulas (1) and (2) described later, includes the determined set values in the attribute information, and outputs the attribute information to the area extraction part 221 together with the image information (step S610).

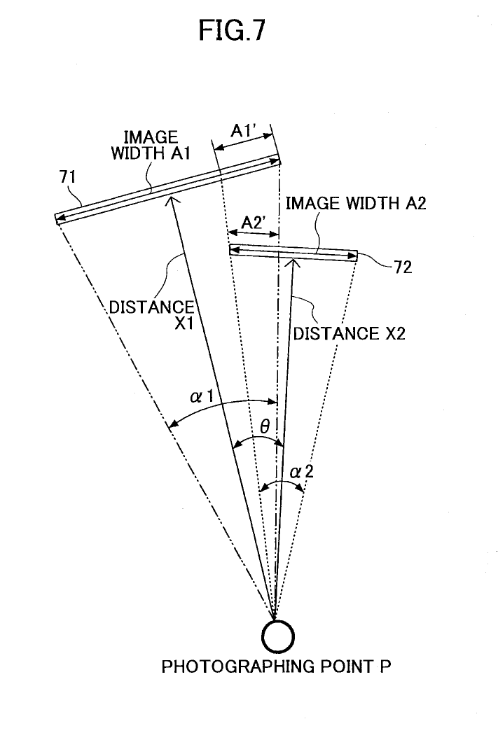

Below, using FIG. 7, calculation of the data comparison areas by the data comparison area setting part 214 will be described. FIG. 7 illustrates calculation of the data comparison areas.

In FIG. 7, two images 71 and 72 photographed at a photographing point P are used as examples. The data comparison area setting part 214 determines based on the following “Determination Formulas 1” whether the image 71 and the image 72 have overlapping-possible parts. “Overlapping-possible parts” or “overlapping-possible areas” mean parts or areas at which sets of image data (or photographs) have a likelihood of overlapping one another.

Overlapping-possible parts exist if α1/2+α2/2≦θ.

Overlapping-possible parts do not exist if α1/2+α2/2>θ. “Determination Formulas 1”

By “Determination Formulas 1”, it is determined whether overlapping-possible parts exist between the images 71 and 72.

When it has been determined that the image 71 and the image 72 have overlapping-possible parts, the data comparison area setting part 214 determines the widths of the overlapping-possible parts by the following formulas (1). It is noted that “A1” denotes the width of the image 71 (“IMAGE WIDTH A1” in FIG. 7), and “A2” denotes the width of the image 72 (“IMAGE WIDTH A2” in FIG. 7). “A1′” denotes the width of the overlapping-possible part in the image 71 having a likelihood of overlapping with the image 72. “A2′” denotes the width of the overlapping-possible part in the image 72 having a likelihood of overlapping with the image 71.

$$\begin{matrix}A {1}^{′} = \frac{A 1}{2} \times \frac{β 2}{β1 + β 2} \\ A {2}^{′} = \frac{A 2}{2} \times \frac{β 2}{β 2 + β 3} \\ β 1 , β 2 , and β 3 have the following values \text{:} \\ β 1 = θ - \frac{α 2}{2} , β 2 = \frac{α 1}{2} + \frac{α 2}{2} - θ , β 3 = θ - \frac{α 1}{2}\end{matrix} \} \qquad ( 1 )$$

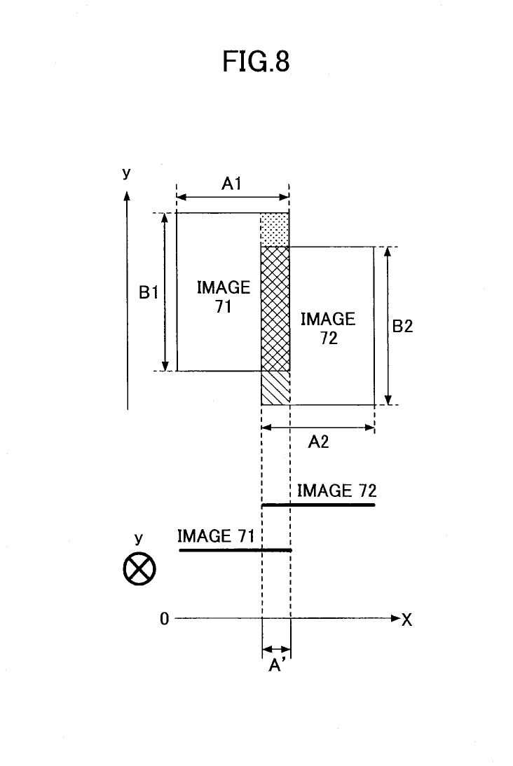

In the calculation results, it should be that A1′≈A2′ (i.e., A1′≈A2′). However, depending on the receiver sensitivity of a Global Positioning System (GPS) provided in the digital camera 110, an error(s) in the width of the data comparison area A1′ and/or the width of the data comparison area A2′ may be increased. At this time, the width of the data comparison area of any one of the two sets of image data (corresponding to the two images 71 and 72) may be used as a reference value, and the width of the other one of the two sets of image data may be adjusted to be the same as the reference value. For example, the values of A1′ and A2′ are compared, and the larger one may be used as the reference value, and the other one may be adjusted thereto. In FIG. 8, “A′” is such that A′=A1′=A2′

Next, the data comparison area setting part 214 sets the heights B1′ and B2′ of the overlapping-possible parts (i.e., the data comparison areas) by the following formulas (2) (see FIG. 8). It is noted that “B1” denotes the height of the image 71, and “B2” denotes the height of the image 72.

$$\begin{matrix}B {1}^{′} = B 1 \\ B {2}^{′} = B 2\end{matrix} \} \qquad ( 2 )$$

The data comparison area setting part 214 includes the thus calculated values of A1′, A2′, B1′ and B2′ in the attribute information as the set values of the data comparison areas, and outputs the attribute information to the area extraction part 221 together with the image data.

It is noted that it is possible to determine whether the image 71 and the image 72 are on the left hand and on the right hand with respect to the photographing point P, respectively, using the parameters “γ1: the direction in which the image 71 has been photographed”; and “γ2: the direction in which the image 72 has been photographed”, described below. The parameters γ1 and γ2 indicating the directions in which the respective images have been photographed are included in the appended information, and are extracted by the information extraction part 212 as the attribute information. The directions in which the respective images have been photographed may be expressed by “unit” and “numerical values”. The “unit” indicates how to express bearings. True bearings or magnetic bearings may be selected as the “unit”. The “numerical values” may be expressed in a range of 0 through 359.99.

Below, the parameters shown in FIGS. 7 and 8 will be described.

α1 denotes an angle of view in the direction of the width of the image 71.

α2 denotes an angle of view in the direction of the width of the image 72.

θ denotes an angle between the image 71 and the image 72 viewed from the photographing point P.

X1 denotes the distance between the object of the image 71 and the photographing point P.

X2 denotes the distance between the object of the image 72 and the photographing point P.

A1 denotes the width (in the frame size of the camera) of the image 71.

A2 denotes the width (in the frame size of the camera) of the image 72.

B1 denotes the height (in the frame size of the camera) of the image 71.

B2 denotes the height (in the frame size of the camera) of the image 72.

It is noted that the parameters that can be obtained as the attribute information are X1, X2, A1, A2, B1 and B2.

The other parameters may be obtained using the following formulas.

The angle θ may be obtained from the following formulas (3). It is noted that all the parameters used in the formulas (3) may be obtained as the attribute information.

$$\begin{matrix}θ = \vert γ 1 - γ 2 \vert \\ γ 1 \text{:} \begin{matrix}the direction in which the image 71 \\ has been photographed\end{matrix} \\ γ 2 \text{:} \begin{matrix}the direction in which the image 72 \\ has been photographed\end{matrix}\end{matrix} \} \qquad ( 3 )$$

The angles of view α1 and α2 may be calculated by the following formulas (4-1). It is noted that all the parameters used in the formulas (4-1) may be obtained as the appended information.

$$\begin{matrix}α = 2 {tan}^{- 1} ( \frac{x}{2 f} ) [ rad ] = \frac{180}{π} \times 2 {tan}^{- 1} ( \frac{x}{2 f} ) [ deg ] \\ x = A 1 , then α = α 1 \\ x = A 2 , then α = α 2 \\ f \text{:} the focal length \\ A 1 , A 2 \text{:} \begin{matrix}the widths of the images 71 , 72 \\ ( the frame sizes of the camera )\end{matrix}\end{matrix} \} \qquad ( 4 \text{-} 1 )$$

It is noted that the parameters calculated by the formulas (3) and (4) are calculated previously before the data comparison area setting part 214 determines whether the two sets of image data have a likelihood of overlapping one another.

Returning to FIG. 6, the area extraction part 221 extracts the data comparison areas from the two sets of image data based on the set values of the data comparison areas included in the attribute information, and stores the extracted data comparison areas in the memories 125 and 126, respectively (step S611).

Next, the data comparison part 222 determines whether the respective sets of image data stored in the memories 125 and 126 have parts that coincide with one another (step S612).

Below, using FIG. 8, the comparison by the data comparison part 222 will be described. FIG. 8 illustrates the comparison of the data comparison areas by the data comparison part 222.

In FIG. 8, the image 71 and the image 72 overlap one another. The data comparison part 222 compares the pixels of image data indicating the data comparison area (A′×B1) of the image 71 and the pixels of image data indicating the data comparison area (A′×B2) of the image 72, and determines whether there are parts at which the pixels coincide between the images 71 and 72. In this regard, it is preferable that the determination as to whether there are parts at which the pixels coincide between the images 71 and 72 is made only when each of the parts has an area equal to or greater than a certain threshold, in consideration of such a situation that although the respective parts do not actually correspond to the same object, some pixels thereof coincide between the images 71 and 72 by accident. The threshold may be determined by an experiment, for example.

In a case where the image data has parts at which the pixels coincide between the images 71 and 72 (step S612 YES), the folder addition part 231 creates a new folder (step S613). Any one of new folders thus created is a folder in which image data is stored, where it has been determined in step S612 that the image data has parts at which the pixels coincide between corresponding images and thus it has been determined as being able to be combined. In a case where the image data has no parts at which the pixels coincide between the images 71 and 72 (step S612 NO), the process proceeds to step S615.

Next, the file selection part 232 stores the image data, for which it has been determined in step S612 that the image data has parts at which the pixels coincide between corresponding images, in the folder created in step S613 (step S614).

Next, the image data selection part 200 determines whether image data that has not been processed yet in the processing starting from step S607 exists in the folder selected in step S606 (step S615). In a case where the corresponding image data exists (step S615 YES), the process returns to step S607, and the corresponding image data is processed in the process starting from step S607 in the same way as that described above. In a case where no corresponding image data exists (step S615 NO), the image data selection part 200 determines whether any folder that stores plural sets of image data and has not been processed yet exists in the hard disk drive 125 (step S616). In a case where the corresponding folder(s) exists (step S616 YES), the process proceeds to step S606, and the corresponding folder is processed in the same way as that described above. In a case where no corresponding folder exists (step S616 NO), the image data selection part 200 finishes the process.

Thus, according to the first embodiment described above, based on the attribute information, for plural sets of image data having photographing positions (photographing points) within a certain area, it is determined whether the plural sets of image data have overlapping-possible areas. In a case where the plural sets of image data have overlapping-possible areas, the overlapping-possible areas are calculated and used as data comparison areas. Then, in a case where the data comparison areas have pixels that coincide between the plural sets of image data, the image data sets thus extracted as the data comparison areas are stored in a collecting manner as plural sets of image data that can be combined together. Thereby, it is possible to select image data that can be combined, without prerequisites.

Further, according to the first embodiment, a separate folder is provided for storing areas having parts that coincide between plural sets of image data, other than a folder that stores ordinary image data. Therefore, it is possible to rapidly carry out a photograph combination process in a case of displaying on a monitor, for example.

### Second Embodiment

Below, a second embodiment of the present invention will be described using drawings. According to the second embodiment, only a method of calculating data comparison areas is different from the first embodiment described above. Therefore, only different points from the first embodiment will be described, and, for parts having the same or similar functions as those of the first embodiment, the same reference numerals are given, and duplicate description will be omitted.

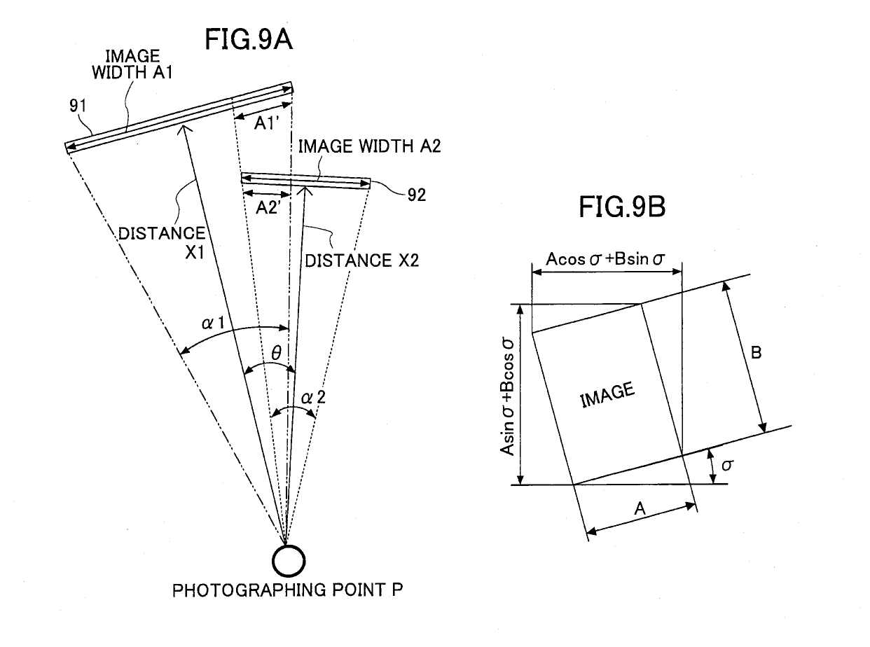

FIGS. 9A and 9B illustrate calculation of data comparison areas according to the second embodiment. FIGS. 9A and 9B show a case where images are inclined. FIG. 9A illustrates calculation of data comparison areas, and FIG. 9B shows an inclination of an image.

In FIGS. 9A and 9B, two images 91 and 92 photographed at a photographing point P are used as an example. According to the second embodiment, the data comparison area setting part 214 determines whether the images 91 and 92 have parts at which the images 91 and 92 have a likelihood of overlapping one another, by the following “Determination Formula 2”:

Overlapping-possible parts exist if α1/2+α2/2+C2≦θ.

Overlapping-possible parts do not exist if α1/2+α2/2+C2>θ. “Determination Formulas 2”

The coefficients “C2” in “Determination Formulas 2” is obtained by the following formulas (4-2), assuming that the image 91 is not inclined while the image 92 is inclined counterclockwise by the angle σ, as shown in FIG. 100.

$$\begin{matrix}α = 2 {tan}^{- 1} ( \frac{x}{2 f} ) [ rad ] = \frac{180}{π} \times 2 {tan}^{- 1} ( \frac{x}{2 f} ) [ deg ] \\ x = A 2 cos σ + B 2 sin σ - A 2 , then α = C 2 \\ f \text{:} the focal length \\ A 2 \text{:} \begin{matrix}the width of the image 92 \\ ( the frame size of the camera )\end{matrix} \\ B 2 \text{:} \begin{matrix}the height of the image 92 \\ ( the frame size of the camera )\end{matrix}\end{matrix} \} \qquad ( 4 \text{-} 2 )$$

When the determination has been made that the images 91 and 92 have parts at which the images 91 and 92 have a likelihood of overlapping one another, the data comparison area setting part 214 calculates the widths of these overlapping-possible parts using the following formulas (5):

$$\begin{matrix}A {1}^{′} = \frac{A 1}{2} \times \frac{β 2}{β 1 + β 2} \\ A {2}^{′} = \frac{A 2}{2} \times \frac{β 2}{β 2 + β 3} + D 2 \\ β 1 , β 2 , β 3 and D 2 have the following values \text{:} \\ β 1 = θ - \frac{α 2}{2} , β 2 = \frac{α 1}{2} + \frac{α 2}{2} - θ , β 3 = θ - \frac{α 1}{2} \\ D 2 = A 2 cos σ + B 2 sin σ - A 2\end{matrix} \} \qquad ( 5 )$$

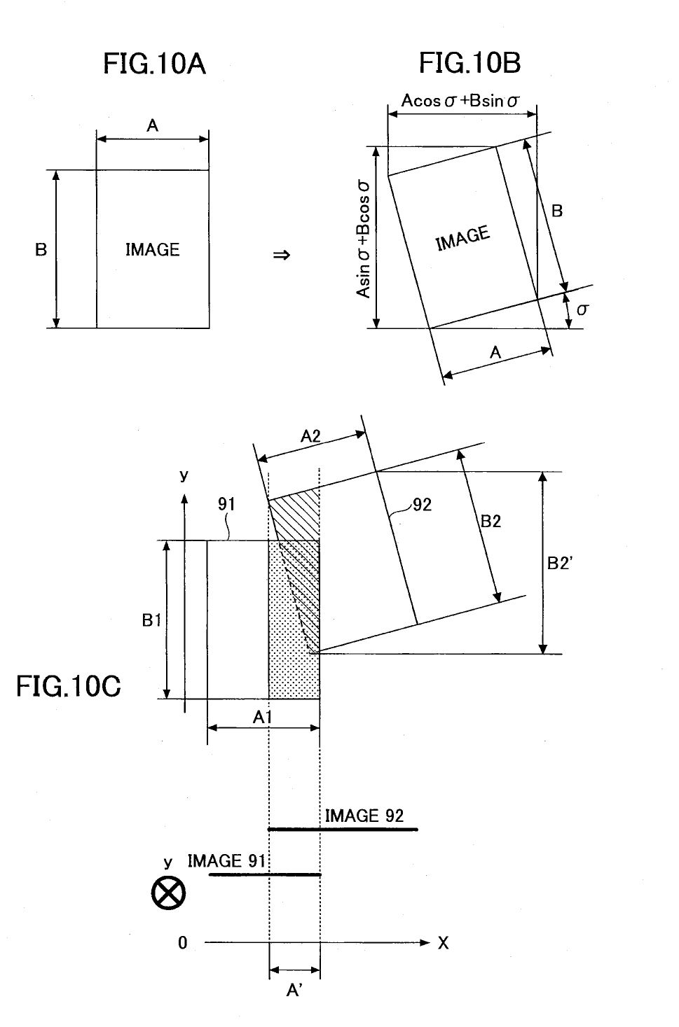

Next, the data comparison area setting part 214 calculates the heights of the overlapping-possible parts (see FIG. 10C) by the following formulas (6):

$$\begin{matrix}B {1}^{′} = B 1 \\ B {2}^{′} = A 2 sin σ + B 2 cos σ\end{matrix} \} \qquad ( 6 )$$

According to the second embodiment, as described above, the calculated values A1′, A2′, B1′ and B2′ are included in attribute information as set values of data comparison areas, and the attribute information is output to the area extraction part 221 together with the image data.

Below, using FIGS. 10A, 10B and 10C, comparison by the data comparison part 222 will be described. FIGS. 10A, 10B and 10C illustrate comparison of data comparison areas by the data comparison part 222 according to the second embodiment. It is noted that FIGS. 10A, 10B and 10C use an example in which, as mentioned above with reference to FIGS. 9A and 9B, the image 91 is not inclined while the image 92 is inclined counterclockwise by an angle σ, as shown in FIG. 10C. FIG. 10A shows an image that is not inclined and FIG. 10B shows an image that is inclined counterclockwise by an angle σ. The data comparison part 222 compares the pixels of image data indicating the data comparison area (A′×B1) of the image 91 and the pixels of image data indicating the part of the image 92 included in the data comparison area (A′×B2′), and determines whether there are parts at which the pixels coincide between the images 91 and 92. It is noted that in FIG. 10C, “A′” is such that A′=A1′=A2′. Further, the same as in the first embodiment described above, it is preferable that the determination as to whether there are parts at which the pixels coincide between the images 91 and 92 is made only when each of the parts has an area equal to or greater than a certain threshold, in consideration of such a situation that although the respective parts do not actually correspond to the same object, some pixels thereof coincide between the images 91 and 92 by accident. The threshold may be determined by an experiment, for example.

According to the second embodiment, by the configuration described above, it is possible to obtain the same or similar advantageous effects as those of the first embodiment.

The present invention is not limited to the specifically disclosed embodiments, and variations and modifications may be made without departing from the scope of the present invention.

The present application is based on Japanese Priority Application No. 2011-123438, filed Jun. 1, 2011 and Japanese Priority Application No. 2012-100579, filed Apr. 26, 2012, the entire contents of which are hereby incorporated herein by reference.

### PATENT REFERENCES

Patent reference 1: Japanese Laid-Open Patent Application No. 2006-080731

Patent reference 2: Japanese Laid-Open Patent Application No. 2000-22934

Patent reference 3: Japanese Laid-Open Patent Application No. 2008-104179

What is claimed is:

1. An image processing apparatus that selects sets of image data that can be combined together, based on appended information concerning the image data taken by an image pickup apparatus, the image processing apparatus comprising:
a storage part configured to select, based on certain information included in the appended information, sets of the image data having positions of the image data taken within a certain area and store the selected sets of image data in a first storage area;
a comparison area calculation part configured to, when plural sets of the image data have been stored in the first storage area, determine whether there are overlapping-possible areas between the plural sets of image data, and, when there are overlapping-possible areas between the plural sets of image data, calculates the overlapping-possible areas as comparison areas;
an image data comparison part configured to determine whether the plural sets of image data coincide in the comparison areas; and
a classification part configured to classify the plural sets of image data based on a determination result of the image data comparison part.

2. The image processing apparatus as claimed in claim 1, wherein
the comparison area calculation part is configured to calculate widths and heights of the comparison areas, and set the widths and heights as set values of the comparison areas in the image data comparison part.

3. The image processing apparatus as claimed in claim 2, wherein
the image data comparison part includes:
an extraction part configured to extract sets of image data of the comparison areas from the plural sets of image data based on the set values, respectively; and
a pixel comparison part configured to determine whether there are pixels that coincide between the extracted sets of image data.

4. The image processing apparatus as claimed in claim 3, wherein
in a case where the pixel comparison part has determined that there are pixels that coincide between the extracted sets of image data, the classification part is configured to store in a second storage area the extracted sets of image data that have been respectively extracted from the plural sets of image data by the extraction part.

5. The image processing apparatus as claimed in claim 1, wherein
the certain information includes position information of a photographing point at which the image data has been photographed; position information of a photographed object concerning the image data; a distance between the photographed object and the photographing point; an inclination between a horizontal direction and a bottom of the image pickup apparatus at a time of the photographing; a focal length at the time of the photographing; a width and a height of an image indicated by the image data; and a photographing direction of the image.

6. The image processing apparatus as claimed in claim 5, wherein
the comparison area calculation part is configured to
calculate an angle between plural images indicated by the plural sets of image data based on the photographing directions of the plural images included in the certain information,
calculate respective angles of view of the plural images in width directions based on the focal lengths and the widths of the plural images included in the certain information, and
calculate the comparison areas using the angle between the plural images and the respective angles of view of the plural images.

7. The image processing apparatus as claimed in claim 6, wherein
the comparison area calculation part is configured to determine, based on the angle between the plural images and the respective angles of view of the plural images, whether there are overlapping-possible areas between the plural images.

8. An image processing method of selecting sets of image data that can be combined together based on appended information concerning the image data taken by an image pickup apparatus, the image processing method comprising:
selecting, based on certain information included in the appended information, sets of the image data having positions of the image data taken within a certain area and store the selected sets of image data in a first storage area;
when plural sets of the image data have been stored in the first storage area, determining whether there are overlapping-possible areas between the plural sets of image data, and, when there are overlapping-possible areas between the plural sets of image data, calculating the overlapping-possible areas as comparison areas;
determining whether the plural sets of image data coincide in the comparison areas; and
classifying the plural sets of image data based on a determination result of the determining.

9. A non-transitory computer readable information recording medium storing an image processing program which, when executed by one or more processors, causes an image processing apparatus, which selects sets of image data that can be combined together based on appended information concerning the image data taken by an image pickup apparatus, to carry out:
selecting, based on certain information included in the appended information, sets of the image data having positions of the image data taken within a certain area and store the selected sets of image data in a first storage area;
when plural sets of the image data have been stored in the first storage area, determining whether there are overlapping-possible areas between the plural sets of image data, and, when there are overlapping-possible areas between the plural sets of image data, calculating the overlapping-possible areas as comparison areas;
determining whether the plural sets of image data coincide in the comparison areas; and
classifying the plural sets of image data based on a determination result of the determining.
